(19) United States
(12) Patent Application Publication
(10) Pub. No.: US 2007/0094521 A1
(43) Pub. Date: Apr. 26, 2007

(54) Current-sensing control system for a microprocessor

(76) Inventors: Robert C. Brooks, Houston, TX (US); Michael R. Durham, Houston, TX (US); Mark D. Tupa, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/257,782

(22) Filed: Oct. 24, 2005

(51) Int. Cl. G06F 1/26

(52) U.S. Cl. 713/300

(57) ABSTRACT

In a control system for a microprocessor, a power supply conductor is configured to supply the power requirements of the microprocessor, and a current-sensing power controller is coupled to the power supply conductor as well as to a thermal control input of the microprocessor. The current-sensing power controller is operable to assert the thermal control input of the microprocessor when current flow in the power supply conductor exceeds a threshold value.

### FIELD OF THE INVENTION

This invention relates generally to techniques for managing heat generation or power consumption in computer systems.

### BACKGROUND

One of the primary problems facing present-day computer designers is how best to manage heat that is generated by the one or more central processing units or other microprocessors in the computer. As circuit density, core voltage and switching speeds increase in a microprocessor, heat generated by the chip also increases. Consequently, many microprocessors are equipped with a heat sink and a fan so that this heat can be transferred efficiently away from the chip die in order to keep the microprocessor within its factory-specified temperature limits.

Another technique that has become known is to equip the microprocessor with an on-chip thermal management system, the effect of which is to throttle some or all of the microprocessor's operations as necessary to maintain a safe die temperature. For example, some microprocessors manufactured by Intel Corporation (“Intel”) exhibit three modes of operation: a normal mode and two thermal management modes called TM1 and TM2. In the normal mode, the microprocessor runs continuously at its full clock speed. In the TM1 mode, the microprocessor runs at its full clock speed but not continuously. Instead, the microprocessor's internal clock is halted periodically according to a fixed duty cycle. In the TM2 mode, the microprocessor's core voltage and clock speed are reduced.

Universally, microprocessor thermal management modes such as TM1 and TM2 have been invoked responsive to a measurement of temperature made with a temperature sensing device such as a thermistor or a thermal diode. For example, the above-mentioned thermal management systems from Intel include on-chip temperature sensing circuitry that functions automatically to place the microprocessor in a thermal management mode when the die temperature has reached a predetermined limit. When such a thermal management mode is active, the microprocessor asserts an externally-visible signal called “prochot” so that external systems may respond appropriately. When the chip's thermal management system becomes inactive, the microprocessor unasserts prochot.

The prochot signal is bidirectional. It not only indicates when the on-chip thermal management system has been invoked internally, but it also can be asserted by external systems to force the on-chip thermal management system to become active. This bidirectional aspect of the prochot signal was provided by Intel so that a microprocessor could be throttled by a temperature-sensing voltage regulator controller that measures the temperature of a voltage regulator system external to the microprocessor. Should the temperature of the voltage regulator system become too high, the voltage regulator controller may assert prochot on the microprocessor in order to reduce the microprocessor's demand for power temporarily, thereby reducing the temperature of the voltage regulator.

### BRIEF DESCRIPTION OF THE DRAWINGS

FIG. 1 is a block diagram illustrating a computer containing a current-sensing thermal control system according to a general preferred embodiment of the invention.

FIG. 2 is a graph of current versus time generally illustrating preferred behavior for the current-sensing thermal control system of FIG. 1.

FIG. 3 is a schematic diagram illustrating the current-sensing thermal control system of FIG. 1 in more detail according to one of several specific preferred embodiments of the invention.

### DETAILED DESCRIPTION OF THE PREFERRED EMBODIMENTS

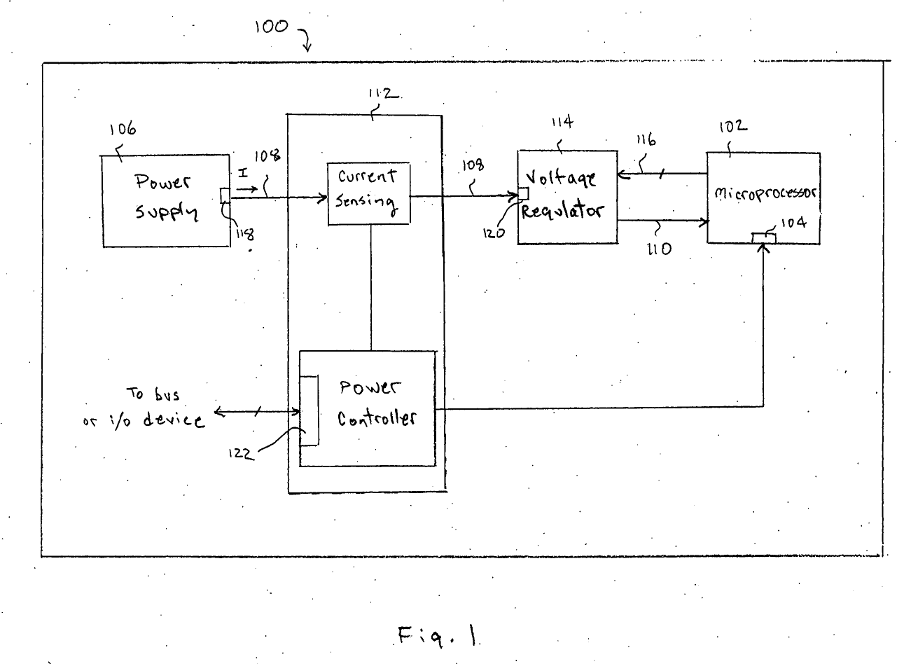

FIG. 1 illustrates a computer 100 that includes a current-sensing control system according to a preferred embodiment of the invention. In addition to traditional components such as RAM memory, a disk, monitor, keyboard and mouse (not shown), computer 100 includes a microprocessor 102 that has a thermal control input 104. Thermal control input 104 represents any mechanism by which logic external to microprocessor 102 can cause the microprocessor to change its power requirements temporarily to a reduced but non-zero level. For example, thermal control input 104 may be the prochot signal on an Intel microprocessor.

Computer 100 also includes a power supply 106 and at least one power supply conductor 108, 110 configured to supply the power requirements of microprocessor 102. A current-sensing power controller 112 is coupled to power supply conductor 108 or 110, and to thermal control input 104. In most computers, a voltage regulator 112 is also present and is disposed between power supply 106 and microprocessor 102 as shown in the drawing. In such computers, current-sensing power controller 112 may alternatively be coupled to power supply conductor 110 in lieu of power supply conductor 108 without deviating from the scope of the invention as claimed herein. It is common in such computers, however, for microprocessor 102 to be able to request varying supply voltages from voltage regulator 114 using signals 116. Therefore, the configuration shown in the drawing is believed to be simpler to implement, as the voltage supplied at output 118 of power supply 106 and received at input 120 of voltage regulator 114 is normally a constant value within a small tolerance.

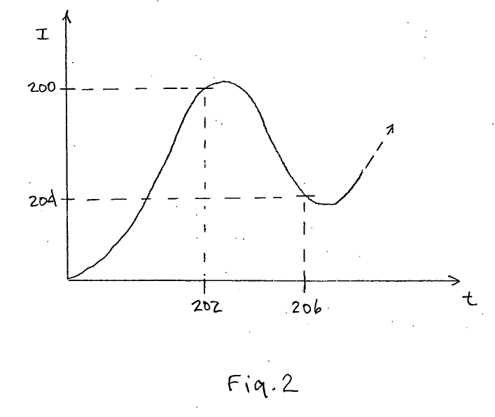

The behavior of current-sensing power controller 112 is to assert thermal control input 104 when current flow in power supply conductor 108/110 exceeds a first threshold value. The result will be that microprocessor 102 will reduce its power requirements and consequently its temperature. Current-sensing power controller 112 may be further operable to unassert thermal control input 104 when current flow in power supply conductor 108/110 falls below a second threshold value lower than the first. This style of operation is visualized in FIG. 2, which is a graph of current I flowing in power supply conductor 108/110 versus time t. As current I increases, it approaches first threshold value 200. Once it reaches threshold value 200 at time 202, current-sensing power controller 112 asserts thermal control input 104, which causes current I to begin to decrease. Once current I has decreased to second threshold value 204 at time 206, current-sensing power controller 112 may unassert thermal control input 104, at which point current I may begin to increase once again. The half-period represented between times 202 and 204 may be any value and may vary over time and with the characteristics of microprocessor 102 and its time-varying load. In one embodiment, current I was found to oscillate between thresholds 200 and 202 at a frequency on the order of milliseconds. The shape of the curve shown in the drawing is for illustrative purposes only; it need not be sinusoidal in practice.

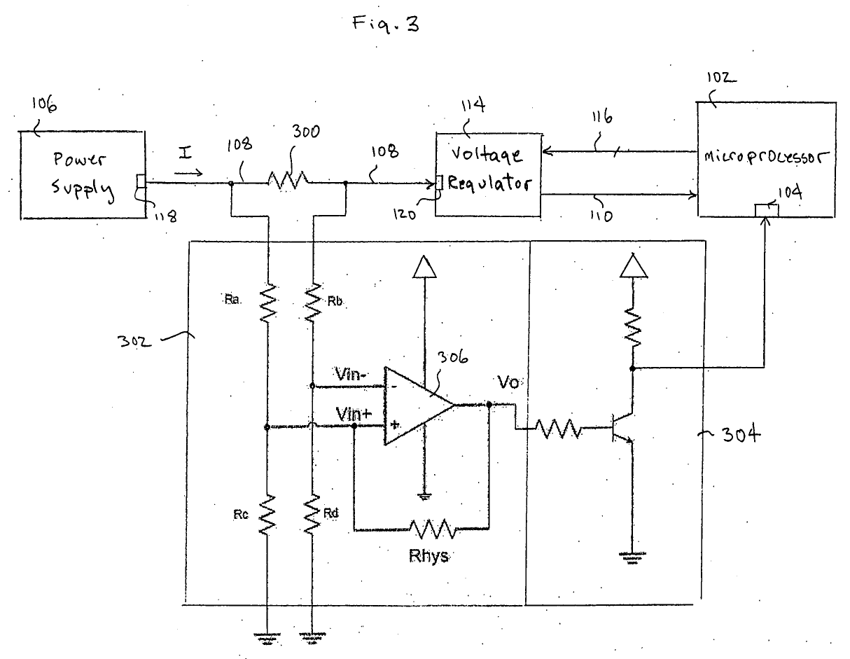

Current-sensing power controller 112 may take a wide variety of forms without deviating from the scope of the invention as claimed herein. Such forms will be apparent to those having ordinary skill in the art and having reference to this specification. For example, numerous methods are known for sensing current flow in a conductor, including lossy methods utilizing one or more components in series with the conductor, as well as so-called lossless methods that utilize electromagnetic sensing techniques such as hall-effect devices and transformers. Any of these or similar techniques may be employed when implementing a system in accordance with the invention. One simple and inexpensive implementation is illustrated in FIG. 3.

In the embodiment of FIG. 3, a series resistor 300 is employed inline with power supply conductor 108. (For a 12 volt power supply supplying up to about 12 amps, a value on the order of 0.01 ohms might be appropriate for resistor 300. Other values may be appropriate as well, of course, depending on the application.) A threshold detector circuit 302 is coupled to either end or resistor 300, and a switch 304 is coupled to thermal control input 104. Threshold detector circuit 302 is operable to change the state of switch 304 (by switching Vₒ from one state to another) responsive to a voltage measured across resistor 300. The voltage across resistor 300 varies with the current flowing in power supply conductor 108.

For the implementation shown in FIG. 3, threshold current values 200,204 may be determined and changed by choosing appropriate values for resistors Rₐ, R_{b}, R_{c}, R_{d} and R_{hys} in accordance with known methods given the assumption that component 306 is an operational amplifier with essentially infinite input impedance and infinite open-loop gain. Threshold detector circuit 302 and its related components would preferably not include devices whose values or characteristics are designed intentionally to vary with temperature, such as thermistors or thermal diodes. The inclusion of such devices would cause difficulty in establishing stable threshold points.

In alternative embodiments, the values of one or both of thresholds 200, 204 may be determined programmatically by writing a data value into a configuration register 122 (referring again to FIG. 1). Such a register may store one or more bits of information and may be coupled, for example, to a bus or input/output device in computer 100 so that its value may be changed when and as appropriate. The mechanism used to set a current threshold responsive to data in register 122 may vary depending on the implementation of current-sensing power controller 112. In the embodiment of FIG. 3, for example, additional or alternative resistors may be switched into or out of threshold detector circuit 302 using FETs whose gates are controlled directly or indirectly responsive to the value stored in configuration register 122.

One of the advantages of the invention over temperature-sensing controllers is that the current-sensing embodiments of the invention can be implemented more inexpensively than can temperature-sensing controllers. This is so because embodiments of the invention do not require the use of thermistors or thermal diodes. Moreover, it is frequently possible to sense current using already-existing series resistances such as the FETs found in switching power supplies, which may further reduce the cost of implementation.

Another advantage provided by the invention is that it allows microprocessor power to be controlled independently of microprocessor temperature. The relationship between microprocessor power and temperature varies from one microprocessor family/model/stepping/frequency to another. Thus, the ability to control microprocessor power independently of microprocessor temperature is valuable, since numerous different microprocessors may be installed in the host computer without changing the design or even the settings of the thermal control system of the invention.

While the invention has been described in detail with reference to preferred embodiments thereof, the described embodiments have been presented by way of example and not by way of limitation. It will be understood by those skilled in the art that various changes may be made in the form and details of the described embodiments without deviating from the spirit and scope of the invention as defined by the appended claims.

What is claimed is:

1. A control system for a microprocessor having a thermal control input, comprising:
a power supply conductor configured to supply the power requirements of the microprocessor; and
a current-sensing power controller coupled to the power supply conductor and to the thermal control input of the microprocessor;
wherein the current-sensing power controller is operable to assert the thermal control input of the microprocessor when current flow in the power supply conductor exceeds a first threshold value.

2. The control system of claim 1, wherein:
the current-sensing power controller is further operable to unassert the thermal control input of the microprocessor when current flow in the power supply conductor falls below a second threshold value lower than the first threshold value.

3. The control system of claim 1, wherein:
the current-sensing power controller comprises a resistor in series with the power supply conductor, a threshold detector circuit coupled to the resistor, and a switch coupled to the thermal control input of the microprocessor; and
the threshold detector circuit is operable to change the state of the switch responsive to a voltage across the resistor, which voltage varies with the current flow in the power supply conductor.

4. The control system of claim 1, wherein:
the current-sensing power controller comprises a component in series with the power supply conductor between an output of a power supply and an input of a voltage regulator.

5. The control system of claim 1:
further comprising a configuration register; and
wherein the current-sensing power controller is operable to determine the first threshold value responsive to data written into the configuration register.

6. The control system of claim 2:
further comprising a configuration register; and
wherein the current-sensing power controller is operable to determine at least one of the first and second threshold values responsive to data written into the configuration register.

7. A computer, comprising:
a microprocessor operable in at least first and second modes, the second mode requiring less power than the first mode, and having a control input that, if asserted by a circuit external to the microprocessor while the microprocessor is in the first mode, causes the microprocessor to enter the second mode;
a power supply conductor external to the microprocessor configured to supply the power requirements of the microprocessor; and
a current-sensing thermal control system external to the microprocessor, coupled to the power supply conductor and to the control input of the microprocessor, and operable to sense an amount of current passing through the power supply conductor and to assert the control input when the amount of current exceeds a first threshold value.

8. The computer of claim 7, wherein:
the current-sensing thermal control system is further operable to unassert the control input of the microprocessor when the amount of current falls below a second threshold value lower than the first threshold value.

9. The computer of claim 7, wherein:
the current-sensing thermal control system is coupled to the power supply conductor between an output of a power supply and an input of a voltage regulator.

10. The computer of claim 7:
further comprising a configuration register; and
wherein the current-sensing thermal control system is operable to determine the first threshold value responsive to data written into the configuration register.

11. The computer of claim 8:
further comprising a configuration register; and
wherein the current-sensing thermal control system is operable to determine at least one of the first and second threshold values responsive to data written into the configuration register.

12. A control system for a microprocessor, comprising:
a power supply conductor configured to supply the power requirements of the microprocessor;
means for sensing an amount of current flowing in the power supply conductor; and
means for causing the microprocessor to transition between first and second operating modes responsive to the amount of current sensed in the power supply conductor, wherein the power requirements of the microprocessor are less in the second operating mode than in the first operating mode, but are non-zero in both modes.

13. The control system of claim 12, wherein:
the means for changing the power requirements of the microprocessor asserts a thermal control input of the microprocessor when the amount of current exceeds a first threshold value, and unasserts the thermal control input of the microprocessor when the amount of current falls below a second threshold value lower than the first threshold value.

14. A method for controlling the temperature of or the power consumed by a microprocessor, comprising:
sensing an amount of current flowing in a power supply conductor configured to supply the power requirements of the microprocessor; and
causing the microprocessor to transition between first and second operating modes responsive to the amount of current sensed in the power supply conductor, wherein the power requirements of the microprocessor are less in the second operating mode than in the first operating mode, but are non-zero in both modes.

15. The method of claim 14, wherein:
causing the microprocessor to transition between first and second operating modes comprises asserting a thermal control input of the microprocessor when the amount of current exceeds a first threshold value, and unasserting the thermal control input of the microprocessor when the amount of current falls below a second threshold value lower than the first threshold value.

16. The method of claim 14, further comprising:
writing a data value into a configuration register; and
setting the first threshold value responsive to the data value.

17. The method of claim 15, further comprising:
writing a data value into a configuration register; and
determining at least one of the first and second threshold values responsive to the data value.
